(19) United States
(12) Patent Application Publication
(10) Pub. No.: US 2005/0020820 A1
(43) Pub. Date: Jan. 27, 2005

(54) Fiber-reactive azo dyestuffs

(76) Inventor: Raimund Bitsch, Grenzach-Wyhlen (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/496,189

(22) PCT Filed: Nov. 22, 2002
(86) PCT No.: PCT/IB02/04921

(30) Foreign Application Priority Data
Nov. 23, 2001 (GB) 0128110.4

(51) Int. Cl. C09B 62/08; C09B 62/16

(52) U.S. Cl. 534/632

(57) ABSTRACT

According to the invention there are provided fiber-reactive dyestuffs which are compounds of the formula (I) wherein the substituents are defined as in claim 1, a process making the same and their use in dyeing or printing hydroxy-group-containing organic substrates.

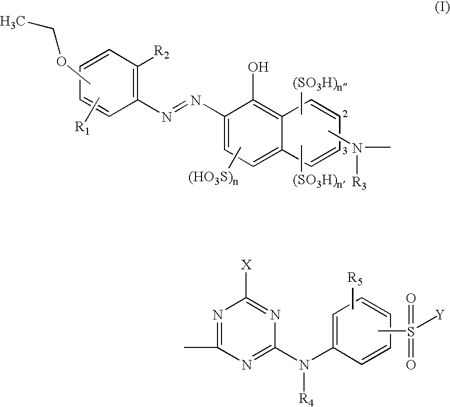

This invention relates to fiber-reactive dyestuffs, a process of making the same and to their use in dyeing or printing hydroxy-group-containing or nitrogen-containing organic substrates.

DE3204259 discloses water-soluble coloured compounds having fibre-reactive properties. EP52985 discloses reactive monoazo scarlet dyes.

However, there is still a need for dyestuffs with improved properties.

According to the invention there are provided fiber-reactive dyestuffs which are compounds of the formula (I) 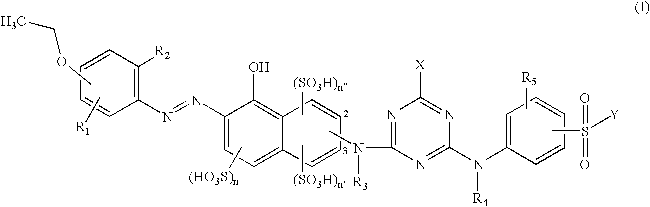
wherein
R₁ is H; unsubstituted C₁₋₄alkyl; substituted C₁₋₄alkyl; C₁₋₄alkoxy; —OH; —COOH; —CN; —NH₂ or —NHCH₃,
R₂ is H; —SO₃H; —COOH; unsubstituted C₁₋₄alkyl; substituted C₁₋₄alkyl; C₁₋₄alkoxy; —OH; —CN; —NH₂ or —NHCH₃,
R₃ is H; unsubstituted C₁₋₄alkyl or substituted C₁₋₄alkyl,
R₄ is H; unsubstituted C₁₋₄alkyl or substituted C₁₋₄alkyl,
R₅ is H; unsubstituted C₁₋₄alkyl; substituted C₁₋₄alkyl; C₁₋₄alkoxy; —OH; —COOH; —CN; —NH₂ or —NHCH₃,
X is —Cl or —F,
Y is —CH═CH₂ or —CH₂CH₂-Z, wherein Z is a radical which can be eliminated by alkali,
n, n′ and n″ signify independently from each other 0 or 1, with the proviso that the sum of n+n′+n″ is always 2 or 3,
   the amino-trazinyl moitie is at the position 2 or 3 attached to the naphtyl ring and salts thereof as well as mixtures of such compounds.

The alkyl groups can be linear or branched.

Preferred substituents for the alkyl groups are halogen, —OH, —CN, —NH₂ or —COOH.

In preferred compounds the the amino-trazinyl moitie is at the position 3 attached to the naphtyl ring.

Preferably,
R₁ is H; unsubstituted C₁₋₂alkyl; substituted C₁₋₂alkyl or C₁₋₂alkoxy,
R₂ is —SO₃H; —COOH; substituted C₁₋₂alkyl; —OH; —CN; —NH₂ or —NHCH₃,
R₃ is H; unsubstituted C₁₋₂alkyl or substituted C₁₋₂alkyl,
R₄ is H; unsubstituted C₁₋₂alkyl or substituted C₁₋₂alkyl,
R₅ is H; unsubstituted C₁₋₂alkyl; substituted C₁₋₂alkyl; C₁₋₂alkoxy; —OH; —COOH; —CN; —NH₂ or —NHCH₃,
X is —Cl or —F,
Y is —CH═CH₂ or —CH₂CH₂-Z, wherein Z is —Cl or —OSO₃H,
n, n′ and n″ signify independently from each other 0 or 1, with the proviso that the sum of n+n′+n″ is always 2 or 3.

Preferred compounds according to formula (I) have the following formula (Ia) 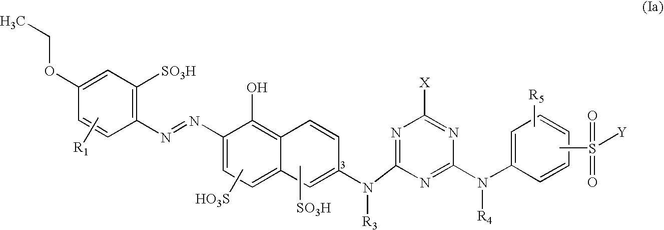
wherein
R₁ is H; unsubstituted C₁₋₂alkyl; substituted C₁₋₂alkyl or C₁₋₂alkoxy,
R₃ is H; unsubstituted C₁₋₂alkyl or substituted C₁₋₂alkyl,
R₄ is H; unsubstituted C₁₋₂alkyl or substituted C₁₋₂alkyl,
R₅ is H; unsubstituted C₁₋₂alkyl; substituted C₁₋₂alkyl; C₁₋₂alkoxy; —OH; —COOH; —CN; —NH₂ or —NHCH₃,
X is —Cl or —F,
Y is —CH═CH₂ or —CH₂CH₂-Z, wherein Z is —Cl or —OSO₃H,
   and salts thereof as well as mixtures of such compounds.

More preferred compounds according to formula (I) have the following formula (Ib) 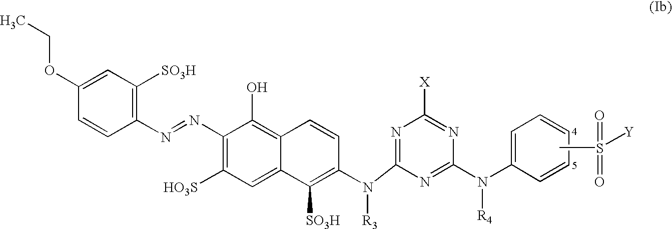
wherein
R₃ is H; unsubstituted C₁₋₂alkyl or substituted C₁₋₂alkyl,
R₄ is H; unsubstituted C₁₋₂alkyl or substituted C₁₋₂alkyl,
X is —Cl or —F,
Y is —CH═CH₂ or —CH₂CH₂-Z, wherein Z is —Cl or —OSO₃H,
   and salts thereof as well as mixtures of such compounds.

Preferably, in a compound of formula (Ib) the —SO₂Y is in position 4 or 5.

When a fiber-reactive dyestuff of formula (I), (Ia) and/or (Ib) is in its salt-form, the cation associated with the sulpho-groups is not critical and may be any of those non-chromo-phoric cations conventional in the field of fiber-reactive dyestuffs provided that the corresponding salt is substantially water-soluble. Examples of such cations are alkali metal cations, for example potassium, lithium or sodium ions and ammonium cations, e.g. mono-, di-, tri- and tetra-methyl or mono-, di-, tri- and tetra-ethyl ammonium cations. The cations may be the same or different, i.e. the compounds may be in mixed salt-form.

A fiber-reactive dyestuff of formula (I), (Ia) and/or (Ib) or a mixture thereof displays good compatibility with other known dyestuffs. Accordingly, it may be mixed with other dyestuffs to form a composition, which can be used to dye or print suitable substrates. Said other dyestuffs must be compatible with a compound of formula (I), (Ia) and/or (Ib) or its mixtures, that is, they must have similar dyeing or printing properties, for example fastness properties.

Accordingly, the invention provides in another of its aspects a dyeing or printing composition comprising a fiber-reactive dyestuff of the formula (I), (Ia) and/or (Ib) or a mixture thereof.

In another aspect of the invention there is provided a process of forming a fiber-reactive dyestuff of formula (I), (Ia) and/or (Ib) or a salt thereof comprising the step of reacting a diazotized compound of the formula (II) 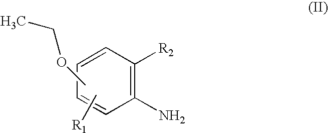
wherein all substituents have the meanings as defined above,
with a compound of the formula (III) 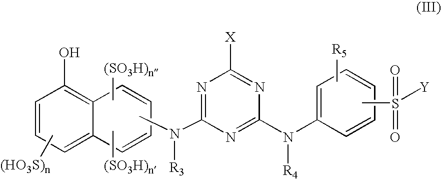
wherein all substituents have the meanings as defined above.

The diazotization process is preferably carried out in an aqueous medium at a temperature of from 0° C. to 40° C., more preferably 0° C. to 25° C. and at a pH of between 3 to 9, more preferably 4 to 8.

A fiber-reactive dyestuff of formula (I), (Ia) and/or (Ib) may be isolated in accordance with known methods, for example by salting out, filtering and drying optionally in vacuum and at slightly elevated temperature.

Depending on the reaction and/or isolation conditions, a fiber-reactive dyestuff of the formula (I), (Ia) and/or (Ib) may be obtained in free-acid or salt-form or mixed salt-form, containing for example one or more of the above-mentioned cations. A fiber-reactive dyestuff of formula (I), (Ia) and/or (Ib) may be converted from salt-form or mixed salt-form to free-acid form or vice versa using conventional techniques.

The compounds of formula (III) are obtainable by a condensation reaction of 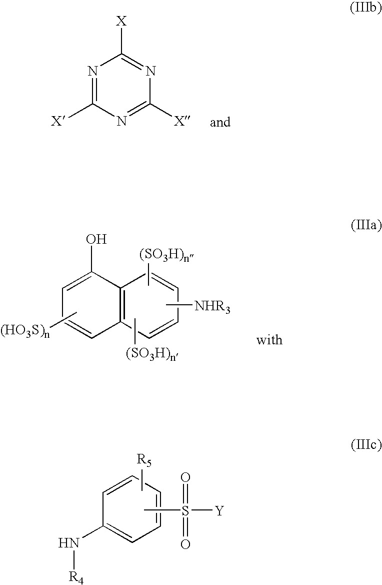
wherein X′ and X″ signify —Cl or —F and all other substituents have the meanings as defined above.

The compounds (IIIa), (IIIb) and (IIIc) are derivable by well-known syntheses from commonplace starting materials well known to persons skilled in the art.

Fiber-reactive dyestuffs of the formula (I), (Ia) and/or (Ib) or a mixture thereof are useful as fiber-reactive dyestuffs for dyeing or printing hydroxy-group-containing or nitrogen-containing organic substrates. Preferred substrates are leather and fibrous materials, which comprise natural or synthetic polyamides and, particularly, natural or regenerated cellulose such as, cotton, viscose and spun rayon. The most preferred substrates are textile materials comprising cotton.

Accordingly, in another aspect of the invention there is provided the use of a fiber-reactive dyestuff according to the formula (I), (Ia) and/or (Ib) or a salt thereof or a mixture as a fiber-reactive dyestuff for dyeing or printing hydroxy-group-containing or nitrogen-containing organic substrates.

Dyeing or printing may be carried out in accordance with known methods conventional in the fiber-reactive dyestuff field.

In a preferred dyeing process the exhaust-dyeing method is used at temperatures within the range of from 40° C. to 100° C., more preferably 50° C. to 80° C. A fiber-reactive dyestuff of formula (I), (Ia) and/or (Ib) or a mixture thereof give good exhaust and fixation yields. Moreover, any unfixed dyestuff is easily washed from the substrate.

In a preferred printing process, the padding method is used, for example pad-steam, pad-thermofix, pad-dry, pad-batch, pad-jig and pad-roll.

Alternatively, printing may be carried out using ink-jet methods.

Accordingly, in another aspect of the invention there is provided a process for the preparation of ink-jet inks comprising the use of a dyestuff of formula (I), (Ia) and/or (Ib) or of a mixture of dyestuffs of formula (I), (Ia) and/or (Ib).

A dyeing or print obtained with said fiber-reactive dyestuff exhibits good fastnesses.

Dyeings and prints obtained using mixtures of dyestuffs display good fastness properties which are comparable with those fastness properties obtained with a compound of formula (I), (Ia) and/or (Ib) alone.

Accordingly, in another aspect of the invention there is provided a hydroxy-group-containing or nitrogen-containing organic substrate dyed or printed with a fiber-reactive dyestuff of formula (I), (Ia) and/or (Ib) of a mixture of dyestuffs of formula (I), (Ia) and/or (Ib).

The following examples illustrate the invention. In the examples all parts and percentages are by weight unless indicated to the contrary, and all temperatures are given in degrees Centigrade.

### EXAMPLE 1

95.8 parts 3-amino-8-naphthol-4,6-disulfonic acid (dissolved in 200 parts of water at a pH of 6.5) are condensed with a suspension of 55.4 parts cyanuric chloride acid in 120 parts of ice-water at 0-10° C. and pH 1.5-2.5. The reaction mixture comprising the compounds of formula (IV) 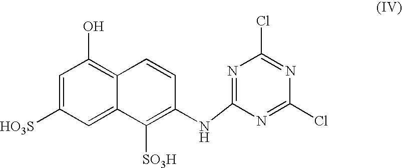
is condensed with 84.3 parts of 1-aminobenzene-4-β-sulphatoethylsulphone at 20-40° C. and the pH is kept at 1.5-4.5. A compound of formula (V) 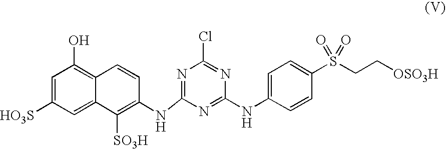
is obtained.

65.1 parts p-phenetidin-2-sulfonic acid (dispersed in 750 parts of ice-water and 75 parts of concentrated hydrochloric acid) are diazotized with 75 parts of 4 N sodium nitrite solution at 0-10° C. The mixture is stirred for two hours and excess nitrous acid is destroyed by means of amidosulfonic acid. The resulting diazonium salt dispersion is added to the compound of formula (V), the pH value is risen from 4.5-8 with 15% sodium carbonate solution. The reaction mixture (SOLUTION 1) is mixed with 315 parts of sodium chloride and the precipitated product is filtered off and dried in vacuum at 50° C.

A compound of formula (VI) 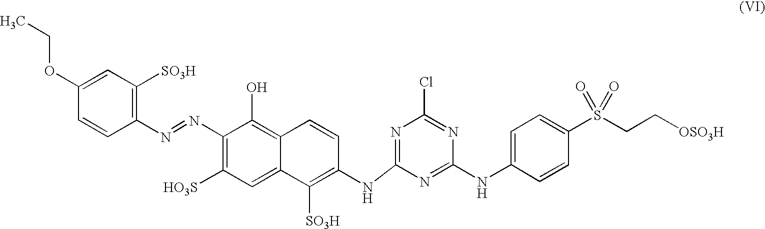
is obtained, which dyes cellulose fibers in scarlet shades.

### EXAMPLE 2

SOLUTION 1 is treated with 1 equivalent of 1 N sodium hydroxide at 10° C. to give the a compound of formula (VII) 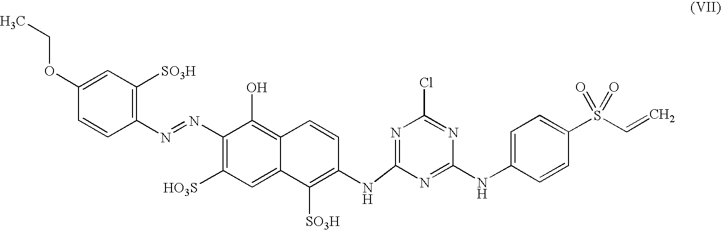
which dyes cellulose fibers in scarlet shades.

### EXAMPLE 3

95.8 parts 3-amino-8-naphthol-4,6-disulfonic acid are dissolved in 200 parts of water and condensed with 40.5 parts cyanuric fluoride acid at −5-0° C., whereas the pH is kept at 5-5.5 to give a compound of formula (VIII).

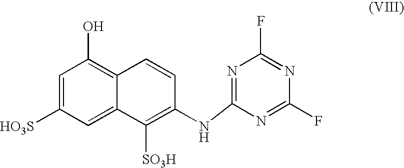

The reaction mixture comprising the compound of formula (VIII) is condensed with 84.3 parts of 1-aminobenzene-4-p-sulphatoethylsulphone at 0-20° C. and the pH is kept at 5.5-6 to give a solution comprising a compound of formula (IX).

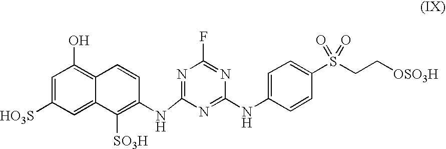

65.1 parts p-phenetidin-2-sulfonic acid (dispersed in 750 parts of ice-water and 75 parts of concentrated hydrochloric acid) are diazotized with 75 parts of 4 N sodium nitrite solution at 0-10° C. The mixture is stirred for two hours and excess nitrous acid is destroyed by means of amidosulfonic acid. The resulting diazonium salt dispersion is added to the solution which comprises a compound of formula (IX), the pH value is risen from 5.5-8 with 15% sodium carbonatesolution. The reaction mixture is mixed with 315 parts of sodium chloride and the precipitated product is filtered off and dried in vacuum at 50° C.

A compound of formula (X) 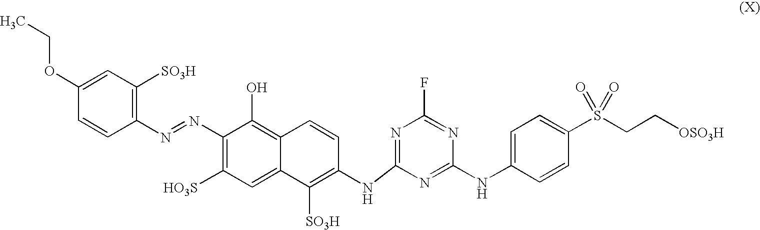
is obtained, which dyes cellulose fibers in scarlet shades.

### TABLE EXAMPLES 4-14

The following examples 4-14 are made according the methods described in example 1(Y═—CH₂CH₂OSO₃H) or Example 2 (Y═—CH=CH₂).

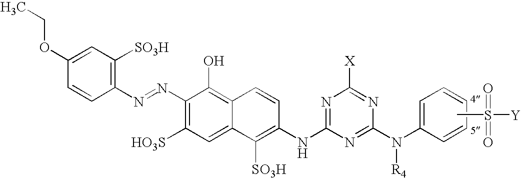

| Ex. | R₄ | X | Position of —SO₂Y— | Y |
|---|---|---|---|---|
| 4 | H | Cl | 5″ | —CH₂CH₂OSO₃H |
| 5 | —CH₂CH₃ | Cl | 5″ | —CH₂CH₂OSO₃H |
| 6 | H | Cl | 5″ | —CH═CH₂ |
| 7 | —CH₂CH₃ | Cl | 5″ | —CH═CH₂ |
| 8 | H | F | 5″ | —CH₂CH₂OSO₃H |
| 9 | —CH₂CH₃ | F | 5″ | —CH₂CH₂OSO₃H |
| 10 | H | F | 4″ | —CH═CH₂ |
| 11 | H | F | 5″ | —CH═CH₂ |
| 12 | —CH₂CH₃ | F | 5″ | —CH═CH₂ |
| 13 | —CH₂CH₃ | Cl | 4″ | —CH₂CH₂OSO₃H |
| 14 | —CH₂CH₃ | Cl | 4″ | —CH═CH₂ |

### Application Example A

0.3 Part of the dyestuff of Example 1 is dissolved in 150 parts of demineralized water and 12 parts NaCl. The dyebath is heated to 60° C., then 10 parts of cotton fabric (bleached) are added. After 30 minutes at 60° C., 3 part of sodium carbonate (calcined) are added to the bath. The addition is done in portion of 0.1, 0.3, 0.6 and 2 parts each 10 min. During the addition of sodium carbonate the temperature is kept at 60° C. Subsequently, the dyebath is heated to 60° C., and dyeing is effected for a further one hour at 60° C.

The dyed fabric is then rinsed with running cold water for 3 minutes and afterwards with running hot water for a further 3 minutes. The dyeing is washed at the boil for 15 minutes in 500 parts of demineralized water in the presence of 0.25 part of Marseille soaps. After being rinsed with running hot water (for 3 minutes) and centrifuged, the dyeing is dried in a cabinet drier at about 70° C. A scarlet cotton dyeing with excellent light and wet fastness properties is obtained.

Similarly, the dyestuffs of Example 2-14 as well as the mixtures of dyestuffs of Examples 1-14 are employed to dye cotton in accordance with the method described in Application Example A.

### Application Example B

To a dyebath containing in 100 parts of demineralized water and 8 parts Glauber's salt (calcined) 10 parts of cotton fabric (bleached) are added. The bath is heated to 50° C. within 10 minutes, and 0.5 part of the dyestuff of Example 1 is added. After a further 30 minutes at 50° C., 1 part of sodium carbonate (calcined) is added. The dyebath is then heated to 60° C. and dyeing is continued at 60° C. for a further 45 minutes.

The dyed fabric is rinsed with running cold and then hot water and washed at the boil according to the method of application Example A. After rinsing and drying a scarlet cotton dyeing is obtained.

Similarly, the dyestuffs of Example 2-14 as well as the mixtures of dyestuffs of Examples 1-14 are employed to dye cotton in accordance with the method described in Application Example B.

### Application Example C

A printing paste consisting of

| | |
|---|---|
| 40 | parts of the dyestuff of Example 1 |
| 100 | parts of urea |
| 350 | parts of water |
| 500 | parts of a 4% sodium alginate thickener and |
| 10 | parts of sodium bicarbonate |
| 1000 | parts in all |

is applied to cotton fabric in accordance with conventional printing methods.

The printed fabric is dried and fixed in steam at 102-104° C. for 4-8 minutes. It is rinsed in cold and then hot water, washed at the boil (according to the method described in Application Example A) and dried. A scarlet print is obtained which has good general fastness properties.

Similarly, the dyestuffs of Example 2-14 as well as the mixtures of dyestuffs of Examples 1-14 are employed to print cotton in accordance with the method given in Application Example C.

### Application Example D

2.5 parts of the dyestuff obtained in Example 1 are dissolved with stirring at 25° C. in a mixture of 20 parts diethyleneglycol and 77.5 parts water to obtain a printing ink suitable for ink jet printing.

Similarly the dyestuffs of Example 2-14 as well as the mixtures of dyestuffs of Examples 1-14 can also be used in a manner analogous to that described in Application Examples D.

1. A compound according to formula (I) 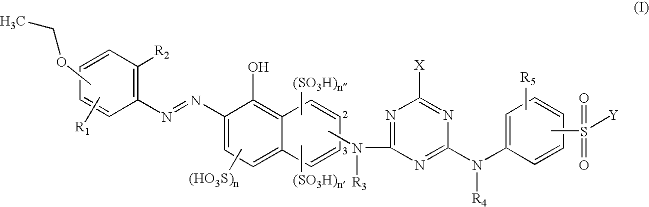
wherein
R₁ is H; unsubstituted C₁₋₄alkyl; substituted C₁₋₄alkyl; C₁₋₄alkoxy; —OH; —COOH; —CN; —NH₂or —NHCH₃,
R₂ is H; —SO₃H; —COOH; unsubstituted C₁₋₄alkyl; substituted C₁₋₄alkyl; C₁₋₄alkoxy; —OH; —CN; —NH₂ or —NHCH₃,
R₃ is H; unsubstituted C₁₋₄alkyl or substituted C₁₋₄alkyl,
R₄ is H; unsubstituted C₁₋₄alkyl or substituted C₁₋₄alkyl,
R₅ is H; unsubstituted C₁₋₄alkyl; substituted C₁₋₄alkyl; C₁₄alkoxy; —OH; —COOH; —CN; —NH₂or —NHCH₃,
X is —Cl or —F,
Y is —CH═CH₂ or —CH₂CH₂-Z, wherein Z is a radical which can be eliminated by alkali,
n, n′ and n″ are independently from each other 0 or 1, with the proviso that the sum of n+n′+n″ is always 2 or 3,
the amino-trazinyl moitie is at the position 2 or 3 attached to the naphtyl ring.

2. A compound of formula (I) according to claim 1 wherein
R₁ is H; unsubstituted C₁₋₂alkyl; substituted C₁₋₂alkyl or C₁₋₂alkoxy,
R₂ is —SO₃H; —COOH; substituted C₁₋₂alkyl; —OH; —CN; —NH₂ or —NHCH₃,
R₃ is H; unsubstituted C₁₋₂alkyl or substituted C₁₋₂alkyl,
R₄ is H; unsubstituted C₁₋₂alkyl or substituted C₁₋₂alkyl,
R₅ is H; unsubstituted C₁₋₂alkyl; substituted C₁₋₂alkyl; C₁₋₂alkoxy; —OH; —COOH; —CN; —NH₂ or —NHCH₃,
X is —Cl or —F,
Y is —CH═CH₂ or —CH₂CH₂-Z, wherein Z is —Cl or —OSO₃H,
n, n′ and n″ are independently from each other 0 or 1, with the proviso that the sum of n+n′+n″ is always 2 or 3.

3. A compound of formula (la) according to claim 1 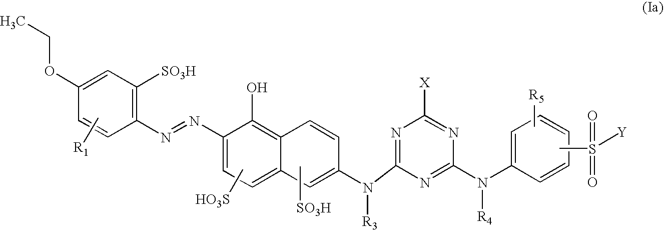
wherein
R₁ is H; unsubstituted C₁₋₂alkyl; substituted C₁₋₂alkyl or C₁₋₂alkoxy,
R₃ is H; unsubstituted C₁₋₂alkyl or substituted C₁₋₂alkyl,
R₄ is H; unsubstituted C₁₋₂alkyl or substituted C₁₋₂alkyl,
R₅ is H; unsubstituted C₁₋₂alkyl; substituted C₁₋₂alkyl; C₁₋₂alkoxy; —OH; —COOH; —CN; —NH₂ or —NHCH₃,
X is —Cl or —F,
Y is —CH═CH₂ or —CH₂CH₂-Z, wherein Z is —Cl or —OSO₃H.

4. A compound of formula (Ib) according to claim 1 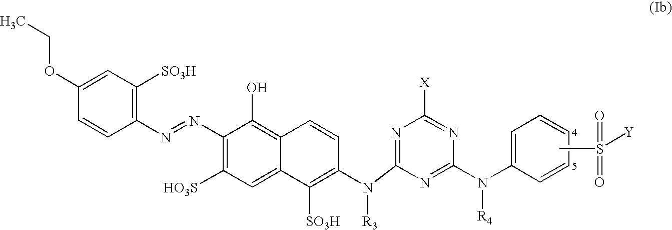
wherein
R₃ is H; unsubstituted C₁₋₂alkyl or substituted C₁₋₂alkyl,
R₄ is H; unsubstituted C₁₋₂alkyl or substituted C₁₋₂alkyl,
X is —Cl or —F,
Y is —CH═CH₂ or —CH₂CH₂-Z, wherein Z is —Cl or —OSO₃H.

5. A process of forming a compound of formula (I), as defined in claim 1 or a salt thereof comprising the step of reacting a diazotized compound of the formula (II) 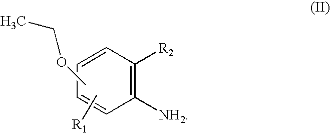
wherein R₁ and R₂ have the meanings as defined in claim 1,
with a compound of the formula (III) 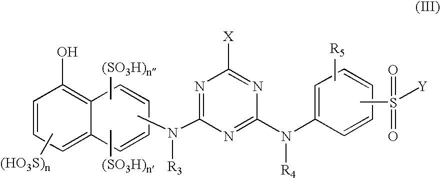
wherein X, Y, R₃, R₄, R₅, n, n′ and n″ have the meanings as defined in claim 1.

6. A process for dyeing a hydroxy-group-containing or nitrogen-containing organic substrate comprising the step of dyeing the substrate with at least one compound according to claim 1 or at least one salt of the compound according to claim 1.

7. An inkjet ink comprising at least one compound according to claim 1 or at least one salt of a compound according to claim 1.

8. A hydroxy-group-containing or nitrogen-containing organic substrate dyed or printed with a compound according to claim 1.

9. A salt of the compound according to claim 1.

10. A mixture of at least two of the compounds according to claim 1.

11. A process for printing a hydroxy-group-containing or nitrogen-containing organic substrate comprising the step of printing the substrate with at least one compound according to claim 1 or at least one salt of the compound of claim 1.

12. A dyed hydroxy-group-containing or nitrogen-containing organic substrate made in accordance with the process of claim 6.

13. A printed hydroxy-group-containing or nitrogen-containing organic substrate made in accordance with the process of claim 11.

14. A hydroxy-group-containing or nitrogen-containing organic substrate dyed or printed with at least one compound according to claim 2 or at least one salt of a compound according to claim 2.

15. A hydroxy-group-containing or nitrogen-containing organic substrate dyed or printed with at least one compound according to claim 3 or at least one salt of a compound according to claim 3.

16. A hydroxy-group-containing or nitrogen-containing organic substrate dyed or printed with at least one compound according to claim 4 or at least one salt of a compound according to claim 4.

17. An ink-jet ink comprising at least one compound according to claim 2 or at least one salt of a compound according to claim 2.

18. An ink-jet ink comprising at least one compound according to claim 3 or at least one salt of a compound according to claim 3.

19. An ink-jet ink comprising at least one compound according to claim 4 or at least one salt of a compound according to claim 4.
